(19) United States
(12) Patent Application Publication
(10) Pub. No.: US 2023/0001670 A1
(43) Pub. Date: Jan. 5, 2023

(54) SYSTEMS AND METHODS FOR UNIFORM TRANSMISSION IN LIQUID CRYSTAL PANELS

(71) Applicant: Corning Incorporated, Coming, NY (US)

(72) Inventors: Oladapo Olalekan Bello, Horseheads, NY (US); James Gregory Couillard, Ithaca, NY (US); Michael Aaron McDonald, Painted Post, NY (US); Paul George Rickerl, Endicott, NY (US)

(21) Appl. No.: 17/780,340

(22) PCT Filed: Nov. 25, 2020
(86) PCT No.: PCT/US2020/062148

§ 371 Date: May 26, 2022

Related U.S. Application Data
(60) Provisional application No. 62/941,212, filed on Nov. 27, 2019.

(51) Int. Cl. B32B 17/10; B32B 7/023; B32B 7/03; B32B 33/00; B32B 37/00; B32B 37/14; B32B 38/18

(52) U.S. Cl. CPC B32B 17/10504; B32B 17/10036; B32B 7/023; B32B 7/03; B32B 17/10146; B32B 17/10449; B32B 33/00; B32B 37/003; B32B 37/144; B32B 38/1833; B32B 2250/03; B32B 2250/40; B32B 2307/422; B32B 2307/42; B32B 2307/538; B32B 2315/08; B32B 2457/202

(57) ABSTRACT

Various embodiments for configuring LC cells, LC panels, and methods of manufacturing LC panels are provided, comprising: providing a first glass layer and a second glass layer; wherein the first glass layer has first and second surfaces and the second glass layer has first and second surfaces; and at least one of: surface polishing a surface of the first glass layer and second glass layer; and selectively positioning the first glass layer and second glass layer such that, after lamination, based on the positioning or polishing of the glass layers, the resulting LC panel is configured with uniform transmission.

### CROSS REFERENCE TO RELATED APPLICATIONS

This application claims the benefit of priority under 35 U.S.C. § 119 of U.S. Provisional Application No. 62/941,212 filed Nov. 27, 2019, the content of which is incorporated herein by reference in its entirety.

### FIELD OF THE INVENTION

Broadly, the present disclosure is directed towards configurations and methods for preventing, reducing, and/or mitigating non-uniform transmissions (e.g. dark spots and/or light spots) in an LC panel and/or LC window for automotive applications and/or architectural applications.

### BACKGROUND

Liquid crystal windows present many challenges in commercialization, especially with respect to manufacture of large-dimensioned architectural windows or automotive windows. Improved performance and manufacturability are desired.

### SUMMARY

Smart windows incorporating a dimmable layer (e.g. a liquid crystal layer) can be used to control light transmission through the window, thereby improving occupant comfort and reducing energy costs. Liquid crystal windows using thick glass are very heavy, as the thick glass greatly increases the weight of the LC cell, which also contributes to difficulty transporting and installing the window.

In one aspect, a method is provided, comprising: providing a first glass layer and a second glass layer; wherein the first glass layer comprises a first surface and a second surface, and the second glass layer comprises a first surface and a second surface, surface polishing at least one of: the first surface of the first glass layer; the second surface of the first glass layer; the first surface of the second glass layer; and the second surface of the second glass layer to provide at least one polished layer on at least one of the first glass layer and the second glass layer; assembling a plurality of LC panel component layers to form a stack, wherein the LC panel component layers comprise: the first glass layer; a first interlayer; an LC cell; a second interlayer; and the second glass layer; removing any entrained air between the LC panel component layers of the stack to form a curable stack; laminating the curable stack to form a liquid crystal panel; wherein via the surface polishing step, the liquid crystal panel is configured with a uniform transmission.

In some embodiments, during the assembling step, the at least one polished layer is facing one of: the first interlayer or the second interlayer.

In some embodiments, surface polishing at least one of: the first surface of the first glass layer; the second surface of the first glass layer; and at least one of: the first surface of the second glass layer; and the second surface of the second glass layer to provide at least one polished layer on the first glass layer and at least one polished layer on the second glass layer.

In some embodiments, during the assembling step, the polished layer on the first glass layer is facing the first interlayer and the polished layer on the second glass layer is facing the interlayer.

In some embodiments, the laminating step further comprises heating the curable stack to a lamination temperature for a duration of time.

In some embodiments, the laminating step further comprises applying pressure to the LC panel component layers during lamination.

In some embodiments, the uniform transmission comprises not greater than 2% disparity in a transmission region, as compared to adjacent transmission regions in the LC panel.

In some embodiments, uniform transmission is detected via visual observation.

In some embodiments, uniform transmission is detected via spectrophotometer.

In some embodiments, surface polishing comprises removing peaks extending above 50 microns, as measured from the surface plane of the corresponding first glass layer or second glass layer.

In some embodiments, surface polishing comprises reducing out-of-plane discontinuities in the first glass layer or second glass layer by at least 25%; or at least 50%; or at least 75% when comparing the out-of-plane discontinuities of the polished layer to the same surface of the same glass layer, before polishing.

In another aspect, a method is provided, comprising: assembling a plurality of LC panel component layers to form a stack, wherein the LC panel component layers comprise: a first glass layer having a first surface and a second surface; a first interlayer; an LC cell; a second interlayer; and the second glass layer, having a first surface and a second surface; selectively positioning at least one of: the first glass layer and the second glass layer across the stack to mitigate an additive distortion in the stack from at least one of: the first glass layer and second glass layer; removing any entrained air between the LC panel component layers of the stack to form a curable stack; laminating the curable stack to form a liquid crystal panel; wherein via the selectively positioning step, the liquid crystal panel is configured with a uniform transmission.

In some embodiments, selectively positioning further comprises: orthogonally positioning the first glass layer from a second glass layer to selectively position an interlayer-facing surface of the first glass layer with an interlayer-facing surface of the second glass layer.

In some embodiments, selectively positioning further comprises: determining a smoother side from the first surface and the second surface of the first glass layer, where smoother comprises at least one of: fewer out-of-plane discontinuities and/or lower out-of-plane discontinuities, and positioning the smoother side towards the first interlayer.

In some embodiments, selectively positioning further comprises: determining a smoother side from the first surface and the second surface of the second glass layer, where smoother comprises at least one of: fewer out-of-plane discontinuities and/or lower out-of-plane discontinuities, and positioning the smoother side of the second glass layer towards the second interlayer.

In some embodiments, selectively positioning further comprises: determining a smoother side from the first surface and the second surface of the first glass layer, where smoother comprises at least one of: fewer out-of-plane discontinuities and/or lower out-of-plane discontinuities, positioning the smoother side towards the first interlayer; determining a smoother side from the first surface and the second surface of the second glass layer, where smoother comprises at least one of: fewer out-of-plane discontinuities and/or lower out-of-plane discontinuities, and positioning the smoother side of the second glass layer towards the second interlayer.

In some embodiments, selectively positioning further comprises: determining a direction of bow in the first glass layer; determining a direction of bow in the second glass layer; and positioning the first glass layer and the second glass layer to align bow in a corresponding direction coincident between bow in each of the first glass layer and the second glass layer, thereby mitigating additive bow distortion between the first glass layer and the second glass layer in the stack.

In some embodiments, the method comprises: surface polishing at least one of: the first surface of the first glass layer; the second surface of the first glass layer; the first surface of the second glass layer; and the second surface of the second glass layer to provide at least one polished layer on at least one of the first glass layer and the second glass layer.

In some embodiments, during the assembling step, the at least one polished layer is facing one of: the first interlayer or the second interlayer.

In some embodiments, the method further comprises: surface polishing at least one of: the first surface of the first glass layer; the second surface of the first glass layer; and at least one of: the first surface of the second glass layer; and the second surface of the second glass layer to provide at least one polished layer on the first glass layer and at least one polished layer on the second glass layer.

In some embodiments, during the assembling step, the polished layer on the first glass layer is facing the first interlayer and the polished layer on the second glass layer is facing the interlayer.

In some embodiments, the uniform transmission comprises not greater than 2% disparity in a transmission region, as compared to adjacent transmission regions in the LC panel.

In another aspect, a method is provided, comprising: providing a first glass layer and a second glass layer; wherein the first glass layer has a first surface and a second surface, and the second glass layer has a first surface and a second surface, surface polishing at least one of: the first surface of the first glass layer; the second surface of the first glass layer; the first surface of the second glass layer; and the second surface of the second glass layer to provide at least one polished layer on at least one of the first glass layer and the second glass layer; assembling a plurality of LC panel component layers to form a stack, wherein the LC panel component layers comprise: the first glass layer and the second glass layer, wherein at least one of the first glass layer and second glass layer comprise a polished surface; a first interlayer; an LC cell; a second interlayer; wherein the polished surface towards the corresponding first interlayer or second interlayer and selectively positioning at least one of: the first glass layer and the second glass layer across the stack to mitigate an additive distortion in the stack from at least one of: the first glass layer and second glass layer; removing any entrained air between the LC panel component layers of the stack to form a curable stack; laminating the curable stack to form a liquid crystal panel; wherein via the surface polishing and selectively positioning steps, the liquid crystal panel is configured with a uniform transmission.

Additional features and advantages will be set forth in the detailed description which follows and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the disclosure as it is claimed.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following aspects.

### BRIEF DESCRIPTION OF THE DRAWINGS

These and other features, aspects and advantages of the present disclosure are better understood when the following detailed description of the disclosure is read with reference to the accompanying drawings, in which:

FIG. 1A depicts a schematic cut-away side view of an embodiment of a liquid crystal (LC) panel in accordance with various embodiments of the present disclosure.

FIG. 1B depicts a close-up cut away side schematic view of a region of FIG. 1A, showing a close-up of a portion of the panel, depicting the second glass layer, the interlayer, the conductive layer, and the LC region, which includes an LC mixture and a plurality of spacers, in accordance with one or more embodiment of the present disclosure.

FIG. 2 is a false color contour map of surface topography measurements on a glass layer utilized in the panel (e.g. float glass), which is believed to be a representative sample of tempered soda lime glass (SLG), showing wavy surface discontinuity (out-of-plane discontinuity), with peaks and troughs averaging ˜50 μm high/deep, in accordance with one or more embodiments of the present disclosure.

FIG. 3A depicts a schematic view of an embodiment of an LC panel, showing an LC cell laminated via first and second interlayers, to corresponding first and second glass layers, in accordance with one or more aspects of the present disclosure.

FIG. 3B depicts a schematic view of an embodiment of an LC window, showing an LC panel configured with a frame, seal between frame and panel, and with a coating on a surface of the panel, in accordance with one or more aspects of the present disclosure.

FIG. 4 depicts a method of making an LC panel, in accordance with various embodiments of the present disclosure.

FIG. 5 depicts a flow chart of an embodiment of a method of making an LC panel, in accordance with one or more embodiments of the present disclosure.

FIG. 6 depicts a flow chart of an alternative embodiment of a method of making an LC panel, in accordance with one or more embodiments of the present disclosure.

FIG. 7 provides a flow chart depicting various embodiments of a method for making an LC panel, where various embodiments are depicted for selectively positioning the first glass layer and the second glass layer, in accordance with embodiments of the present disclosure.

FIG. 8 depicts another embodiment a method in accordance with the present disclosure, where both surface polishing and selectively positioning (one, two, and/or three embodiments provided herein) are included, in accordance with various embodiments of the present disclosure.

FIG. 9A-C depicts three comparative illustrations of configuring two glass layers with corresponding bow based on configuration of glass layers (FIG. 9A) or contradicting bow based on configuration of glass layers (FIGS. 9B and 9C), in accordance with one or more aspects of the present disclosure.

### DETAILED DESCRIPTION OF THE DRAWINGS

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

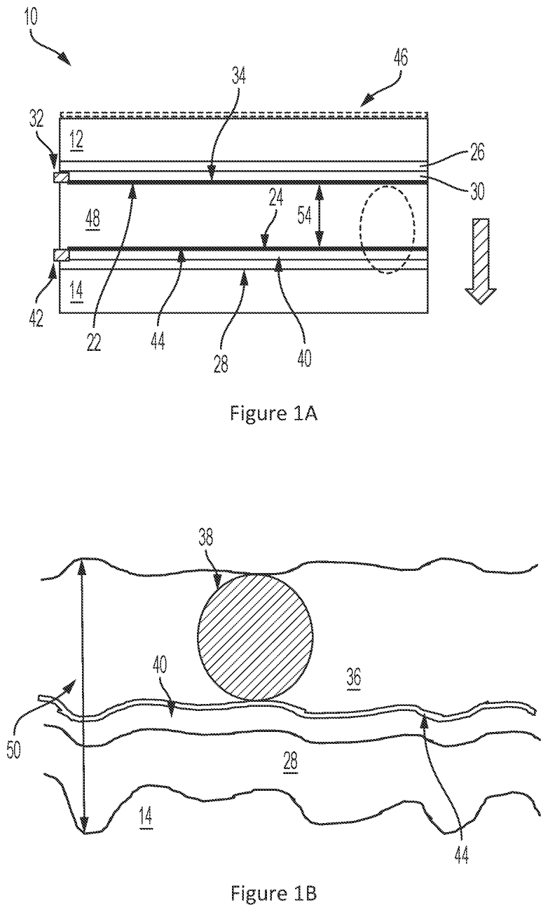

FIG. 1A depicts a schematic cut-away side view of a liquid crystal (LC) panel.

Referring to FIG. 1A, a schematic cut-away side view of an embodiment of a liquid crystal panel 10 is depicted, illustrating the LC cell configured (sandwiched) between two glass layers (e.g. a first glass layer 12 and a second glass layer 14), with corresponding interlayers (e.g. first interlayer 26 and second interlayer 28) positioned between each of the first glass layer 12 and the first side of the LC cell 22, and the second glass layer 14 and the second side of the LC cell 24.

The liquid crystal cell 20 is configured with two glass layers, a first glass layer 30 and a second glass layer 40, set apart in spaced relation from each other with a liquid crystal region 48 defined therebetween. Each of the first glass layer 30 and the second glass layer 40 is configured with a conductive layer (e.g. first conductive layer 34 and second conductive layer 44) where each conductive layer (34, 44) is configured between the LC region 48 and the first or second glass sheets 30, 40, such that the conductive layers 34, 44 are configured in electrical communication with the liquid crystal region.

The liquid crystal region 48 includes a plurality of spacers 38 and an LC mixture 36. The spacers 38 are provided in spaced relation throughout the LC mixture 36, such that the spacers 38 are configured to promote a cell gap that is substantially uniform (e.g. not exceeding a predefined threshold) from one position within the LC cell 20 to another position in the LC cell 20. The LC mixture 36 can include: at least one liquid crystal material, at least one dye, at least one host material, and/or at least one additive. The LC mixture 36 is configured to electrically switch/actuate, thereby providing the actuation element in a corresponding liquid crystal cell 20, liquid crystal panel 10, and liquid crystal window to provide a contrast (e.g. dark) and a non-contrast (e.g. clear) state when actuated. Actuation of the LC mixture 36 is completed by the electrical connections via first electrode 32 (adjacent to the first major side 22 of the LC cell 20) and the second electrode 42 (adjacent to the second major side 24 of the LC cell 20). The electrode (one of 32 and 42) is configured to direct an electrical current or potential from a power source through the corresponding electrode acting as anode, through the corresponding conductive layer (one of 34 or 44), through the LC region 48 to actuate the LC mixture 36, through the corresponding conductive layer (the other of 34 or 44) and exiting the system through the electrode (the other of 32 and 42). By turning on and off the power source, and thereby, the current running through the LC mixture, the LC mixture is actuated from a first transmission state to a second transmission state (where the first transmissions state is different from the second transmission state).

As shown, the LC panel 10 includes a first glass layer 12, a second glass layer 14, an LC cell 20, a first interlayer 26, and a second interlayer 28. The LC cell 20 includes a liquid crystal material 36 (e.g. molecules, dyes, and/or additives), spacers 38 (configured to cooperate with the glass layers to maintain the cell gap in the LC cell), a first conductive layer 34, a second conductive layer 44, a first electrode 32, a second electrode 42, a first sheet of glass 30, and a second sheet of glass 40.

In some embodiments, the first glass layer 12 and second glass layer 14 are thick. In some embodiments, the first glass layer and the second glass layer each have a thickness of at least 3 mm thick. In some embodiments, the first glass layer and the second glass layer each have a thickness of at least 3 mm thick to not greater than 7 mm thick.

In some embodiments, the first sheet of glass 30 and second sheet of glass 40 are thin. In some embodiments, the first glass sheet and the second glass sheet each have a thickness of at not greater than 1 mm thick. In some embodiments, the first glass layer and the second glass layer each have a thickness of at least 0.3 mm thick to not greater than 1 mm thick.

In some embodiments, the first sheet of glass 30 and second sheet of glass 40 are thinner than the first layer of glass 12 and second layer of glass 14.

In some embodiments, the glass sheets (30, 40) are configured in the LC cell 20, adjacent to major surfaces 22, 24 of the LC cell and adjacent to the LC material 36 to retain LC components (e.g. conductive layers (34, 44), LC material 36, spacers 38) in place. In some embodiments, first interlayer 26 is configured between first glass layer 12 and first sheet of glass 30 (first surface 22 of LC cell 20). In some embodiments, second interlayer 28 is configured between second layer of glass 14 and second sheet of glass 40 (second surface 24 of LC cell 20).

In some embodiments, the glass sheet (e.g. first sheet of glass 30 or second sheet of glass 40) is configured with a thickness of less than 1 mm; less than 0.8 mm, less than 0.7 mm, less than 0.5 mm, or less than 0.3 mm. In some embodiments, the first sheet of glass 30 has the same thickness as the second sheet of glass 40. In some embodiments, the first sheet of glass 30 has a different thickness than the second sheet of glass 40.

For example, conductive layer (34 or 44) is configured in the LC cell 20 between the sheet of glass (30 or 40) and the LC region 48. The conductive layer (34 or 44) is attached to one or more electrodes (32 or 34) (e.g. configured to communicate with the conductive layers and a power source (not shown) to direct an electric field across the LC cell 20, actuating the LC panel/smart window to an on position (having a first contrast) and off position (having a second contrast)), based on whether the electric field is on or off.

Each conductive layer includes a conductive film, for example, a transparent conductive oxide. Some non-limiting examples of thin conductive film is ITO (indium tin oxide), FTO (fluorine-doped tin oxide), or metals.

In some embodiments, an alignment layer such as polyimide may be disposed between the thin conductive film and the LC material to promote orientation of the LC molecules (within the LC material 36) with a desired angle.

FIG. 1B depicts a close-up cut away side view of a region of FIG. 1A, showing a close-up of the second glass layer 14 (e.g. tempered SLG), second interlayer 28, and second glass sheet 40 of the LC cell 20, further depicting the LC region's 48 LC mixture 36 and a spacer 38 retained in the LC cell 20. As shown in FIG. 1B, the surface discontinuity of the first glass layer and second glass layer 14 (here, only second glass layer shown) as compared to the second layer of glass 40 is apparent. In this illustrated example, the surface discontinuity attributed to the area 50 of the LC panel 10 is an area of a non-uniformity/discontinuity in the LC cell 20. This example may be viewed by an observer as a dark spot in the LC panel 10. The spacers 38 are configured to extend across the cell gap of the LC cell 20.

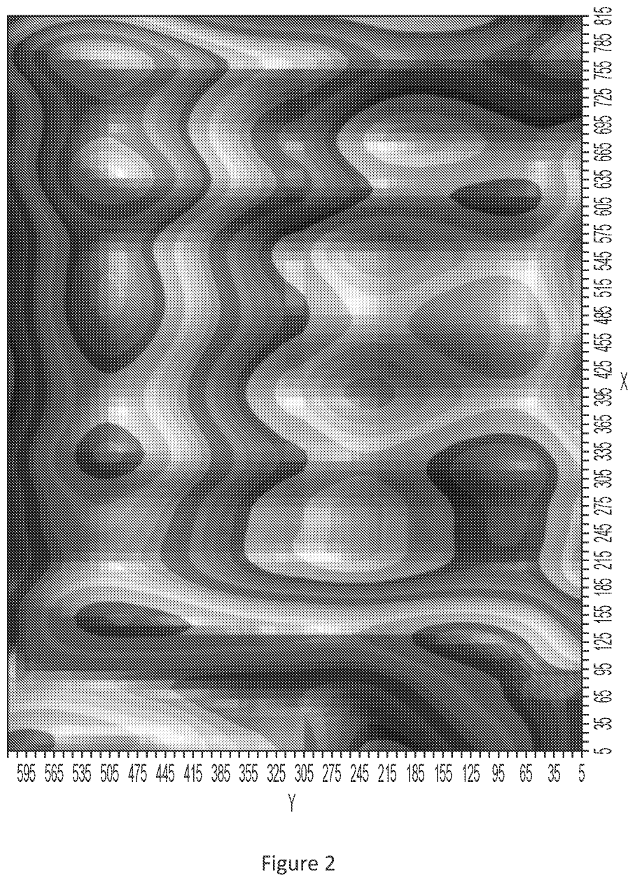

FIG. 2 depicts a contour map of a representative sample of a first glass layer 12 or second glass layer 14 utilized in the LC panel 10 as described herein. The float glass has a surface waviness/contoured topography at production, which can be exacerbated with tempering to provide a surface topography similar to that of the representative example in FIG. 2. This tempered soda lime glass exhibits a surface discontinuity (out-of-plane discontinuity), with peaks and troughs averaging ˜50 μm high/deep, which provides challenges in laminating to manufacture a liquid crystal panel 10.

In one non-limiting example, the waviness can be analytically determined through mechanical or optical measurement devices and in accordance with standard methods. In one non-limiting example, the waviness can be determined by measurement in accordance with ASTM C1651: Standard Test Method for Measurement of Roll Wave Optical Distortion in Heat-Treated Flat Glass. Other standard methods may also be utilized to understand the surface-waviness of the flat glass layers in accordance with one or more embodiments disclosed herein.

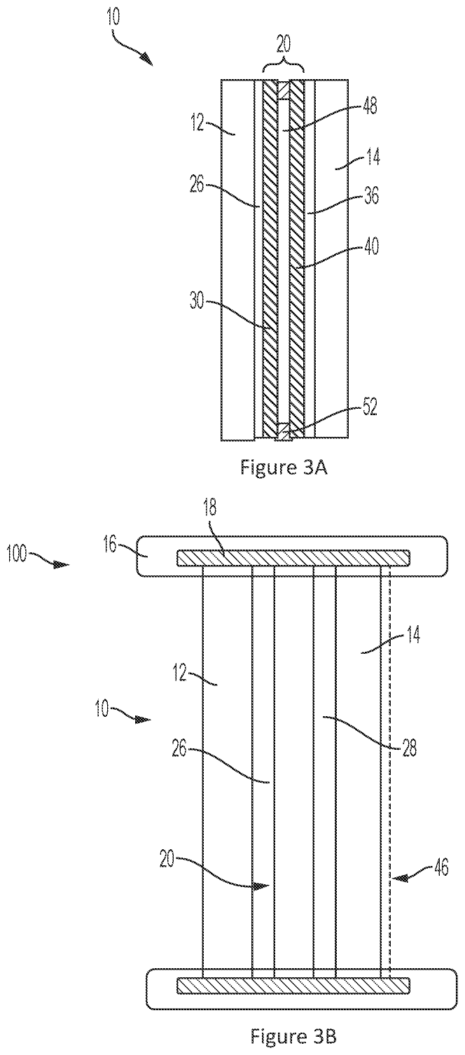

FIG. 3A depicts a schematic cut away side view of an embodiment of a single cell liquid crystal panel 10, which illustrates an LC cell laminated onto two glass layers (12, 14) via two interlayers (26, 28) to form an LC panel 10. The LC panel depicts a symmetrical component configuration, with an axis drawn through the LC material 48, from one portion of the depicted LC cell seal 52 towards the other depicted LC cell seal 52.

FIG. 3B depicts a schematic cut-away side view of an embodiment of a single cell liquid crystal window 100. The LC window 100 includes an LC cell 20 embodied within a panel 10, the panel also having first interlayer 26, second interlayer 28, first glass layer 12, and second glass layer 14. The LC window 100 is configured with a frame 16 configured on an edge of the LC panel 10, with a seal 18 configured between at least a portion of the frame 16 and at least a portion of an edge of the panel 10 to provide compressive engagement of the panel 10 within the frame 16 without damaging the edge of the panel 10. Also, FIG. 3B depicts an optional coating 46 on a surface of the LC panel 10. Here, the coating is configured on the outer surface of the second layer of glass 14 on the LC panel 10.

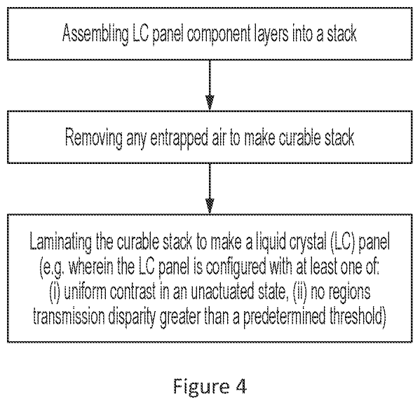

FIG. 4 depicts a method of making an LC panel. As shown, the lamination process includes assembling the LC panel component layers into a stack. The various component layers, including a first glass layer, a first interlayer, an LC cell, a second interlayer, and a second glass layer are placed into contact with one another to form the stack. The interlayer is selected from the group of: polymers and ionomers. As a non-limiting example, the interlayer comprises PVB (polyvinyl butyral) at a thickness of 0.76 mm.

Next, the lamination process includes removing any entrapped or entrained air between the various layers of the stack to form a curable stack. Non-limiting examples of air removal include: nip rolling, using an evacuation pouch, vacuuming via at least one vacuum ring, or a laminating via a flatbed laminator.

Laminating is completed on the curable stack in order to bond the first glass layer and the second glass layer to major surfaces of the LC cell (e.g. as shown in FIG. 1A, generally opposing major surfaces of the LC cell via the corresponding first and second interlayers, which attach (e.g. bond) the first glass layer onto the first surface of the LC cell and the second glass layer on the second side of the LC cell. Non-limiting examples of laminating include utilizing a flatbed laminator or an autoclave. After laminating for a duration of time, at a temperature, and under a target pressure, the curable stack is formed into a liquid crystal (LC) panel.

In a non-limiting example, the LC panel is made into a liquid crystal window by configuring a seal and a frame around an outer edge of the LC panel, to retain the LC panel within the frame. Additionally, electrical communication is configured from a power supply to the electrodes so that the LC window can be actuated via an electrical field directed across the LC window via the electrodes, conductive layers, and LC material.

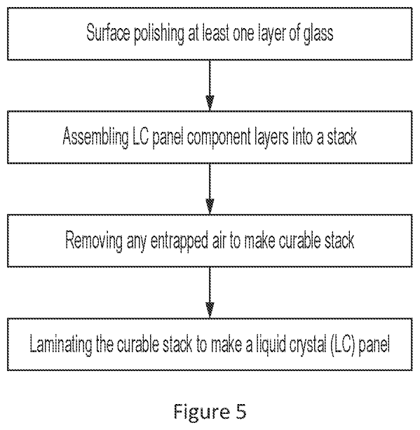

Referring to the following figures, FIGS. 5-9 are generally directed towards embodiments of methods to configure the tempered SLG layer or layers in the LC panel during manufacture to prevent, reduce, and/or eliminate mura (e.g. dark spots). Non-limiting examples include surface polishing the inner surface of one or both of the first glass layer and second glass layer, and/or selectively positioning the first glass layer and second glass layer relative to each other in the stack configuration.

FIG. 5 depicts a flow chart of an embodiment of a method is depicted, in accordance with one or more embodiments of the present disclosure. Referring to FIG. 5, a method provides surface polishing at least one of the tempered SLG layers, assembling the LC panel component layers into a stack, removing any entrapped air to make a curable stack, followed by laminating the curable stack to make a LC panel, wherein, via the surface polishing step, the LC panel, when in a static contrast state, is configured with at least one of: (i) no regions having a transmission disparity greater than a predetermined threshold (as compared to adjacent regions), and/or (ii) uniform contrast/no visually observable dark spots (e.g. in either contrast state).

In some embodiments, surface polishing means surface polishing an inner side (e.g. facing the LC cell and adjacent to the interlayer) of at least one of: the first layer of SLG, the second layer of SLG, or both layers of SLG.

In some embodiments, surface polishing means surface polishing an inner side (e.g. facing the LC cell and adjacent to the interlayer) of both the first layer of SLG and the second layer of SLG.

In some embodiments, surface polishing is configured to remove any tall peaks from the SLG inner surface out-of-plane discontinuity. In some embodiments, surface polishing is configured to remove peaks extending above 50 microns from the surface plane of the SLG. In some embodiments, surface polishing is configured to reduce out-of-plane discontinuities by 75%, or by about 50%, or by about 25%, or by about 10%. In some embodiments, surface polishing is configured to reduce out-of-plane discontinuities by 75% (e.g. from 50 microns to 12.5 microns), or by about 50% (e.g. from 50 microns to 25 microns), or by about 25% (e.g. from 50 microns to 37.5 microns), or by about 10% (from 50 microns to 40 microns).

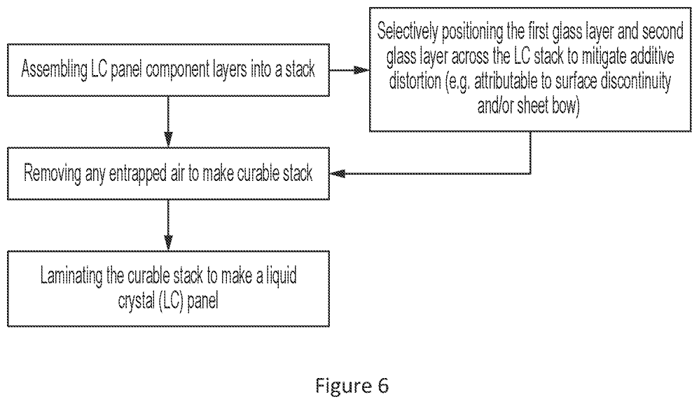

FIG. 6 depicts a flow chart of an alternative embodiment of a method of making an LC panel, in accordance with one or more embodiments of the present disclosure. Referring to FIG. 6, a method of making an LC panel is shown, with an alternative embodiment of selectively positioning the first glass layer and the second glass layer across the LC stack to mitigate additive distortion (e.g. attributable to one or both SLG surface discontinuity and/or one or both SLG layer bow).

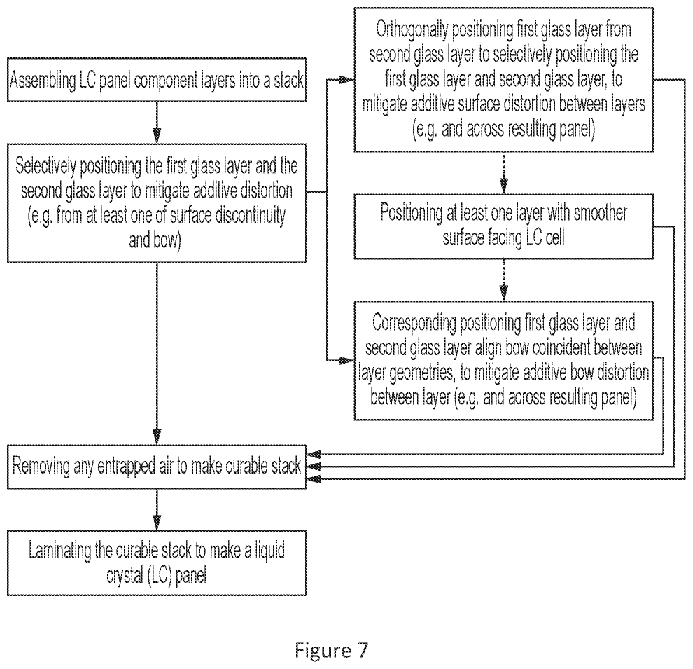

FIG. 7 provides three embodiments for selectively positioning the first glass layer and second glass layer, in accordance with embodiments of the present disclosure. As shown in FIG. 7, one embodiment of selectively positioning the first glass layer and second glass layer includes positioning the layers orthogonally to each other. In such a configuration, when both inner layers of the SLG have quasiperiodic surface discontinuities (e.g. example of quasiperiodic representation depicted in FIG. 2), by orthogonally positioning the layers relative to each other (e.g. one sheet positioned at a 90 degree rotation or 270 degree rotation relative to the other layer). Other angles of rotation and alignment are permissible, but those corresponding to quadrangle (e.g. square and rectangle) are provided herein for illustrative purposes.

In a second embodiment, selectively positioning comprises flipping the orientation of at least one SLG layer. For instance, one side of SLG may have significantly more surface discontinuities than the other, as a function of manufacture from the float or tempering process. Thus, by positioning the smoother surface (e.g. the surface with fewer/lesser surface discontinuities) of at least one SLG layer (or both SLG layers) towards the LC cell, dark spots can be prevented, reduced, and/or eliminated in lamination.

In a third embodiment, selectively positioning comprises positioning the first glass layer and the second glass layer such that the layers have in corresponding aligning bow coincident between sheet geometries. In this configuration, layers are positioned to mitigate bow (e.g. additive bow distortion between layers).

As shown in FIG. 7, selectively positioning can include one, two, or all three embodiments provided in FIG. 7, in accordance with various aspects of the present disclosure.

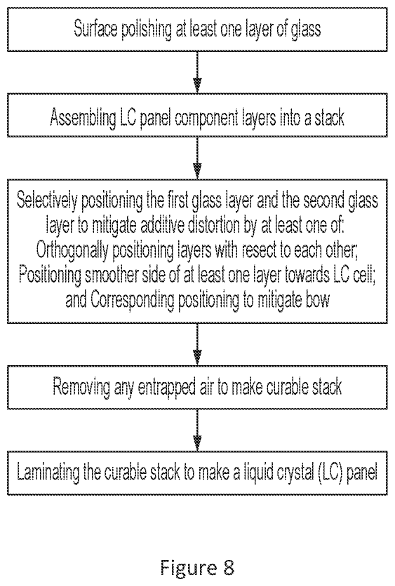

FIG. 8 depicts another embodiment a method in accordance with the present disclosure, where both surface polishing and selectively positioning (one, two, or all three embodiments provided herein) are included, in accordance with various embodiments of the present disclosure.

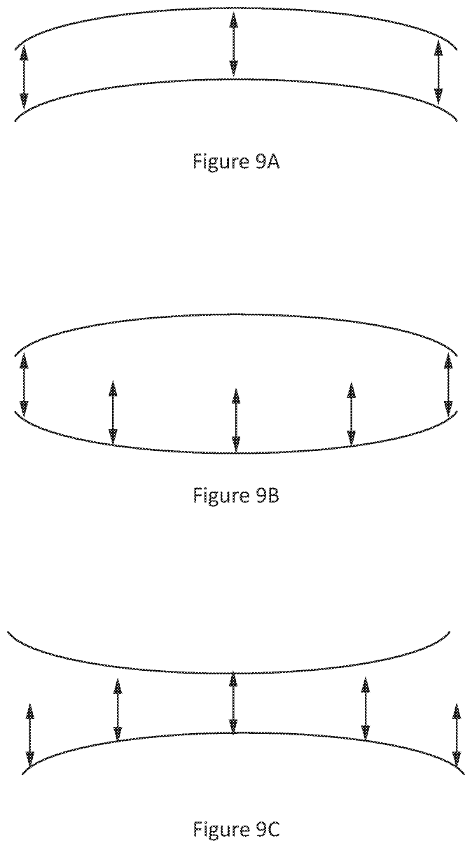

FIG. 9A-C depicts three comparative illustrations of configuring two glass layers with corresponding bow (FIG. 9A) or contradicting bow (FIGS. 9B and 9C). Bow can be measured in accordance with ASTM C1172.

Referring to FIG. 9A, two glass layers are configured with corresponding bow, to mitigate the additive bow by corresponding the layers to maintain coincident orientations of like geometries. To highlight the uniformity in spacing in FIG. 9A and the comparative gaps in FIGS. 9B and 9C, arrows having the same length are positioned between the two glass layers of each example, and there are significant gaps in the example configurations of FIG. 9B (e.g. in the central region) and 9C (e.g. at the edges/end regions).

FIG. 9A provides the two glass layers which are configured (selectively positioned) with a coincident spooning pattern, in accordance with various embodiments of the present disclosure.

In contrast, FIG. 9B is believed to result in significant uniformity issues based on the cell gap differences attributable to the SLG layer configuration (i.e. generally bowing away from each other at the center).

Similarly, FIG. 9C is believed to result in significant uniformity issues based on the cell gap differences attributable to the SLG layer configuration (i.e. generally bowing away from each other at the edges/ends).

In some embodiments, liquid crystal (LC) material is sandwiched between two pieces of commercially available fusion formed borosilicate glass, such as Corning® EAGLE XG® to form the liquid crystal cell. However, such glass has thickness <1 mm, and so is not rigid enough to withstand exposure to the wind and snow loads commonly experienced by large-dimensioned windows in architectural applications. As such, liquid crystal windows of the present disclosure include an LC cell having thin glass (e.g. less than 1 mm), which are laminated to thick (>3 mm) pieces of soda lime glass (SLG) for additional strength and/or support. The SLG is tempered (per ASTM C1048) for additional strength and breakage protection, however, the tempering process is known to induce out-of-plane distortion in the SLG, which can be significant, impacting the LC panel.

After lamination, if the thin glass(es) from the LC cell is well-adhered to the SLG, the out-of-plane distortion from the SLG can pull on the thin glass, which may drive stresses acting on the LC cell, including locally increasing the LC cell gap and/or producing undesirable local changes in visual appearance. The LC panel or resulting LC window can have spots of non-uniform transmission, or regions having 2% or greater variation in visible light transmission relative to the average visible light transmission across the visible area of the panel (e.g. dark spots or light spots). Without being bound by any particular mechanism or theory, non-uniform transmission areas or regions are believed to be attributed to a thicker cell gap in the LC cell, which is generated during manufacturing of the LC window.

One or more advantages of using thin glass to fabricate the LC cell include: (a) compatibility with existing LCD fabrication equipment; lower window weight, making it easier to transport and install and lowering overall carbon footprint; higher visible light transmission in the clear state; thinner overall window structures, and/or additional room for gas in an IGU, thereby improving the insulation efficiency.

One or more embodiments of the present disclosure are directed towards configurations and methods for reducing, preventing, and/or eliminating areas or regions of non-uniform transmission (e.g. dark spots or light spots) in an LC panel. Thus, one or more LC panels of the present disclosure are configured with uniform transmission (e.g. regions at no greater than 2% variation in visible light transmission relative to the average visible light transmission across an adjacent area (visible area) of the window).

In some embodiments, dark spots or light spots (‘spots’) are detectable by visual observation (in a static mode of the liquid crystal window, spots, if any are detectable in at least one of the first contrast state and the second contrast state, where the contrast states are an on position and an off position.

In some embodiments, a spot means that transmission of the window in a region is greater than 2% lower transmission in the dark spot region, as compared to the surrounding, non-dark spot region. As a non-limiting example, transmission is measurable with a spectrometer (e.g. percent transmission or visible light transmission).

In one aspect, a method is provided, comprising: assembling a plurality of LC window component layers to form a stack; removing any entrained air between the component layers of the stack to form a curable stack; laminating the curable stack for a duration of time, at a lamination temperature, and at a pressure to form a liquid crystal window; wherein the liquid crystal window is configured with a uniform transmission.

In some embodiments, a uniform transmission comprises not greater than 2% disparity in a transmission region (e.g. visible light transmission), as compared to adjacent transmission regions.

In some embodiments, uniform transmission is detected via visual observation.

In some embodiments, uniform transmission is detected via spectrophotometer.

The providing step further comprises: assembling further comprises positioning a first glass layer, a first interlayer, an LC cell, a second interlayer, and a second glass layer into a stacked configuration.

In one aspect, an apparatus is provided, comprising: a liquid crystal cell, wherein the liquid crystal cell comprises: a first glass layer, a second glass layer, configured in spaced relation from the first glass layer, and a liquid crystal material comprising an electrically switchable material (e.g. including a first contrast state and a second contrast state) positioned (retained) between the first glass layer and the second glass layer, a plurality of spacers, wherein the spacers are configured to sit between the first glass layer and the second glass layer and among the liquid crystal material, wherein the spacers are configured to maintain a LC gap (e.g. distance from the first glass sheet to the second glass sheet) of the LC cell; a first conductive layer and a second conductive layer, wherein the first conductive layer is configured between the first glass layer and a first side of the LC cell such that the first conductive layer is in electrical communication with the first side of the LC cell, wherein the second conductive layer is configured between the second glass layer and the second LC sidewall such that the second conductive layer is in electrical communication with the second side of the LC cell, a first electrode configured adjacent to a cell perimeter and in electrical communication with the first conductive layer; and a second electrode configured adjacent to the second conductive layer; wherein, the electrodes are configurable to a power source, such that the LC cell is electrically configured to electrically actuate the electrically switchable material in the LC mixture.

In some embodiments, the spacers are configured from a polymer material.

In some embodiments, the first glass layer is a thin glass.

In some embodiments, the first glass layer has a thickness of less than 1 mm.

In some embodiments, the first glass layer has a thickness of not greater than 0.5 mm. In some embodiments, the second glass layer is a thin glass.

In some embodiments, the second glass layer has a thickness of less than 1 mm. In some embodiments, the second glass layer has a thickness of not greater than 0.5 mm.

In some embodiments, the LC gap is not greater than 10 microns.

In some embodiments, the conductive layer comprises ITO and polyimide.

In another aspect, an apparatus is provided, comprising: a liquid crystal cell (LC cell), configured to retain an electrically switchable LC material; a first glass sheet configured along a first side of the LC cell; a second glass sheet configured along a second side of the LC cell; a first interlayer positioned between the first glass sheet and the first side of the LC cell, wherein the first interlayer adheres the first glass layer to the first side of the LC cell; and a second interlayer positioned between the second glass sheet and the second side of the LC cell, wherein the second interlayer is configured to adhere the second glass layer to the second side of the LC cell.

In some embodiments, the apparatus is a laminate.

In some embodiments, the apparatus is a liquid crystal window.

In some embodiments, the liquid crystal window has a surface area of at least 1 foot by at least 2 feet.

In some embodiments, the liquid crystal window has a surface area of at least 2 feet by at least 4 feet.

In some embodiments, the liquid crystal window has a surface area of at least 3 feet by at least 5 feet.

In some embodiments, the liquid crystal window has a surface area of at least 5 feet by at least 7 feet.

In some embodiments, the liquid crystal window has a surface area of at least 7 feet by at least 10 feet.

In some embodiments, the liquid crystal window has a surface area of at least 10 feet by at least 12 feet.

In some embodiments, the apparatus is an architectural liquid crystal window.

In some embodiments, the apparatus is an automotive liquid crystal window.

In some embodiments, the first glass layer comprises a soda lime glass.

In some embodiments, the first glass layer comprises a tempered soda lime glass.

In some embodiments, the first glass layer comprises a thickness of at least 2 mm.

In some embodiments, the first glass layer comprises a thickness of at least 2 mm to not greater than 4 mm.

In some embodiments, the first glass layer comprises a thickness of 3 mm.

In some embodiments, the first glass layer comprises a thickness of 4 mm.

In some embodiments, the second glass layer comprises a soda lime glass.

In some embodiments, the second glass layer comprises a tempered soda lime glass.

In some embodiments, the second glass layer comprises a thickness of at least 2 mm.

In some embodiments, the second glass layer comprises a thickness of at least 2 mm to not greater than 4 mm.

In some embodiments, the second glass layer comprises a thickness of 3 mm.

In some embodiments, the second glass layer comprises a thickness of 4 mm.

In some embodiments, the first interlayer comprises a thickness of not greater than 1 mm.

In some embodiments, the first interlayer comprises a thickness of 0.76 mm.

In some embodiments, the first interlayer comprises a polymer.

In some embodiments, the first interlayer comprises PVB.

In some embodiments, the second interlayer comprises a thickness of not greater than 1 mm.

In some embodiments, the second interlayer comprises a thickness of 0.76 mm.

In some embodiments, the second interlayer comprises a polymer.

In some embodiments, the second interlayer comprises PVB.

In some embodiments, at least one surface of the LC panel comprises a coating.

In some embodiments, at least one surface of the LC panel comprises a low emissivity coating.

In some embodiments, the outer surface of the second glass layer of the LC panel comprises a low emissivity coating. For example, the low emissivity coating can be comprised of a combination of metals and oxides, including non-limiting examples of silicon nitride, metallic silver, silicon dioxide, tin oxide, zirconium oxide, and/or combinations thereof, to name a few.

As some non-limiting examples, the coating includes: a low emissivity coating, an anti-reflective coating; a tint coating; an easy clean coating; or an anti-bird strike coating. In some embodiments, the coating is a partial coating. In some embodiments, the coating is a full coating. In some embodiments (e.g. anti-bird strike coating), the coating is patterned along discrete portions of the surface.

In some embodiments, the laminate comprises a coating on at least one of: a first major surface of the LC panel, a second major surface of the LC panel, and both the first major surface of the LC panel and the second major surface of the LC panel.

In some embodiments, the apparatus is an architectural product.

In some embodiments, the apparatus is an architectural window.

In some embodiments, the apparatus is an automotive window.

Many variations and modifications may be made to the above-described embodiments of the disclosure without departing substantially from the spirit and various principles of the disclosure. All such modifications and variations are intended to be included herein within the scope of this disclosure and protected by the following claims.

### COMPONENT LIST

Window 100

Frame 16

Seal 18

LC panel 10

First glass layer (e.g. thick tempered SLG, thickness of >3 mm) 12

Second glass layer (e.g. thick tempered SLG, thickness of >3 mm) 14

LC cell 20

First side (major surface) of LC cell 22

First interlayer 26

First glass sheet 30

First electrode 32

First conductive layer 34

LC region (includes LC mixture and spacers) 48

Spacers 38

LC mixture (includes LC host(s), molecule(s), dye(s), additives) 36

Second conductive layer 44

Second electrode 42

Second glass sheet 40

Second side (major surface) of LC cell 24

Second interlayer 28

Coating (e.g. Low E coating) 46

LC region seal 52

50 example of mura/discontinuous region/non-uniformity

54 cell gap

1. A method, comprising:
providing a first glass layer and a second glass layer;
wherein the first glass layer comprises a first surface and a second surface, and
the second glass layer comprises a first surface and a second surface,
surface polishing at least one of: the first surface of the first glass layer; the second surface of the first glass layer; the first surface of the second glass layer; and the second surface of the second glass layer to provide at least one polished layer on at least one of the first glass layer and the second glass layer;
assembling a plurality of LC panel component layers to form a stack, wherein the LC panel component layers comprise:
the first glass layer;
a first interlayer;
an LC cell;
a second interlayer; and
the second glass layer;
removing any entrained air between the LC panel component layers of the stack to form a curable stack;
laminating the curable stack to form a liquid crystal panel;
wherein via the surface polishing step, the liquid crystal panel is configured with a uniform transmission.

2. The method of claim 1, wherein during the assembling step, the at least one polished layer is facing one of: the first interlayer or the second interlayer.

3. The method of claim 1, further comprising:
a. surface polishing at least one of: the first surface of the first glass layer; the second surface of the first glass layer; and at least one of: the first surface of the second glass layer; and the second surface of the second glass layer to provide at least one polished layer on the first glass layer and at least one polished layer on the second glass layer.

4. The method of claim 3, wherein during the assembling step, the polished layer on the first glass layer is facing the first interlayer and the polished layer on the second glass layer is facing the interlayer.

5. The method of claim 1, wherein the laminating step further comprises heating the curable stack to a lamination temperature for a duration of time.

6. The method of claim 1, wherein the laminating step further comprises applying pressure to the LC panel component layers during lamination.

7. The method of claim 1, wherein the uniform transmission comprises not greater than 2% disparity in a transmission region, as compared to adjacent transmission regions in the LC panel.

8. The method of claim 1, wherein uniform transmission is detected via visual observation.

9. The method of claim 1, wherein uniform transmission is detected via spectrophotometer.

10. The method of claim 1, wherein surface polishing comprises removing peaks extending above 50 microns, as measured from the surface plane of the corresponding first glass layer or second glass layer.

11. The method of claim 1, wherein surface polishing comprises reducing out-of-plane discontinuities in the first glass layer or second glass layer by at least 25%; or at least 50%; or at least 75% when comparing the out-of-plane discontinuities of the polished layer to the same surface of the same glass layer, before polishing.

12. A method, comprising:
assembling a plurality of LC panel component layers to form a stack, wherein the LC panel component layers comprise:
a first glass layer having a first surface and a second surface;
a first interlayer;
an LC cell;
a second interlayer; and
the second glass layer, having a first surface and a second surface;
selectively positioning at least one of: the first glass layer and the second glass layer across the stack to mitigate an additive distortion in the stack from at least one of: the first glass layer and second glass layer;
removing any entrained air between the LC panel component layers of the stack to form a curable stack;
laminating the curable stack to form a liquid crystal panel;
wherein via the selectively positioning step, the liquid crystal panel is configured with a uniform transmission.

13. The method of claim 12, wherein selectively positioning further comprises:
orthogonally positioning the first glass layer from a second glass layer to selectively position an interlayer-facing surface of the first glass layer with an interlayer-facing surface of the second glass layer.

14. The method of claim 12, wherein selectively positioning further comprises:
determining a smoother side from the first surface and the second surface of the first glass layer, where smoother comprises at least one of: fewer out-of-plane discontinuities and/or lower out-of-plane discontinuities, and
positioning the smoother side towards the first interlayer.

15. The method of claim 12, wherein selectively positioning further comprises:
determining a smoother side from the first surface and the second surface of the second glass layer, where smoother comprises at least one of: fewer out-of-plane discontinuities and/or lower out-of-plane discontinuities, and
positioning the smoother side of the second glass layer towards the second interlayer.

16. The method of claim 1, wherein selectively positioning further comprises:
determining a smoother side from the first surface and the second surface of the first glass layer, where smoother comprises at least one of: fewer out-of-plane discontinuities and/or lower out-of-plane discontinuities,
positioning the smoother side towards the first interlayer;
determining a smoother side from the first surface and the second surface of the second glass layer, where smoother comprises at least one of: fewer out-of-plane discontinuities and/or lower out-of-plane discontinuities, and
positioning the smoother side of the second glass layer towards the second interlayer.

17. The method of claim 12, wherein selectively positioning further comprises:
determining a direction of bow in the first glass layer;
determining a direction of bow in the second glass layer; and
positioning the first glass layer and the second glass layer to align bow in a corresponding direction coincident between bow in each of the first glass layer and the second glass layer, thereby mitigating additive bow distortion between the first glass layer and the second glass layer in the stack.

18. The method of claim 12, further comprising:
a. surface polishing at least one of: the first surface of the first glass layer; the second surface of the first glass layer; the first surface of the second glass layer; and the second surface of the second glass layer to provide at least one polished layer on at least one of the first glass layer and the second glass layer.

19. The method of claim 18, wherein during the assembling step, the at least one polished layer is facing one of: the first interlayer or the second interlayer.

20. The method of claim 18, further comprising:
a. surface polishing at least one of: the first surface of the first glass layer; the second surface of the first glass layer; and at least one of: the first surface of the second glass layer; and the second surface of the second glass layer to provide at least one polished layer on the first glass layer and at least one polished layer on the second glass layer.

21. The method of claim 18, wherein during the assembling step, the polished layer on the first glass layer is facing the first interlayer and the polished layer on the second glass layer is facing the interlayer.

22. The method of claim 18, wherein the uniform transmission comprises not greater than 2% disparity in a transmission region, as compared to adjacent transmission regions in the LC panel.

23. A method, comprising:
providing a first glass layer and a second glass layer;
wherein the first glass layer has a first surface and a second surface, and
the second glass layer has a first surface and a second surface,
surface polishing at least one of: the first surface of the first glass layer; the second surface of the first glass layer; the first surface of the second glass layer; and the second surface of the second glass layer to provide at least one polished layer on at least one of the first glass layer and the second glass layer;
assembling a plurality of LC panel component layers to form a stack, wherein the LC panel component layers comprise:
the first glass layer and the second glass layer, wherein at least one of the first glass layer and second glass layer comprise a polished surface;
a first interlayer;
an LC cell;
a second interlayer; wherein the polished surface towards the corresponding first interlayer or second interlayer and
selectively positioning at least one of:
the first glass layer and the second glass layer across the stack to mitigate an additive distortion in the stack from at least one of: the first glass layer and second glass layer;
removing any entrained air between the LC panel component layers of the stack to form a curable stack;
laminating the curable stack to form a liquid crystal panel;
wherein via the surface polishing and selectively positioning steps, the liquid crystal panel is configured with a uniform transmission.
